(19) United States
(12) Patent Application Publication
(10) Pub. No.: US 2004/0030788 A1
(43) Pub. Date: Feb. 12, 2004

(54) Computer message validation system

(76) Inventors: Gaetano Cimo, Laguna Niguel, CA (US); Jonathan Valesh, Pinon Hills, CA (US); James Valesh, Pinon Hills, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/437,782

(22) Filed: May 14, 2003

Related U.S. Application Data
(60) Provisional application No. 60/380,911, filed on May 15, 2002.

(51) Int. Cl. G06F 15/16

(52) U.S. Cl. 709/229

(57) ABSTRACT

A method and apparatus that validates client messages for compliance with communication protocol specifications and the data content requirements of a computer system. The system builds and uses data filters that validate client message communication protocol. Data content is validated by comparing the outputs of two computers running functionally equivalent software and receiving the same input. One computer is an uncontrolled client system and the other is a controlled system that resides between the client system and the computer system being protected.

### RELATED APPLICATIONS

This application claims priority under 35 U.S.C. §119(e) from Provisional Application No. 60/380,911, filed on May 15, 2002, the entirety of which is hereby incorporated by reference herein.

### BACKGROUND OF THE INVENTION

1. Field of the Invention

This invention relates to a system and method for ensuring valid messages are entered into a computer system. More specifically, this invention relates to systems and methods for avoiding invalid message attacks against a WEB application.

2. Description of the Related Art

WEB servers provide access to numerous, anonymous and uncontrollable clients while attempting to prevent such widespread access from doing great harm. WEB servers may be compromised or disabled when input data does not conform to defined requirements. Whereas accidental errors may be harmful, exploitation intrusions are intended to do damage and often cause catastrophic results. A plethora of security devices and methods have deluged the industry to prevent such intrusions. Devices such as firewalls, virus scanners, software products and HTML forms with data entry validation script provide some security, but they do not prevent clients from entering data that exceeds length restrictions that can cause buffer overflows nor do they prevent the entry of data strings that do not conform to input requirements that can cause damage.

### SUMMARY OF THE INVENTION

In one aspect of the systems and techniques described herein, a WEB server is protected from clients that could cause the WEB server to be compromised in various ways. These include: invasion of harmful software, unauthorized access to internal WEB server control, unauthorized access to private networks via an impaired WEB server, and denial of service

In another aspect of the systems and techniques described herein, the WEB server is protected from invalid and potentially harmful client messages, messages that can cause buffer overflows and message content the WEB server is not programmed to process.

In other aspects of the systems and techniques described herein, the following capabilities may be provided: intercept client messages and validate them prior to passing them on to the WEB server; validate all elements of the client message including HTTP protocol, URLs and client message bodies [form inputs]; validate client messages that may be modified by script and/or browser plug-ins; perform the tasks listed above automatically and in real time; perform without negatively impacting the performance [response time] of the WEB server; perform the functions listed above with no modification to the WEB server; perform the functions listed above with no modification to the client system; perform the functions listed above for a variety of WEB server software, hardware and/or operating systems; and perform the functions listed above for a variety of client software, hardware and/or operating systems.

For purposes of summarizing, certain aspects, advantages and novel features have been described herein. It is to be understood that not necessarily all such advantages may be achieved in accordance with any particular embodiment. Thus, the systems described may be embodied or carried out in a manner that achieves or optimizes one advantage or group of advantages as taught herein without necessarily achieving other advantages as may be taught or suggested herein.

### BRIEF DESCRIPTION OF THE DRAWINGS

The above mentioned and other features will now be described with reference to the drawings of the present system and associated methods. The shown embodiments are intended to illustrate, but not to limit the invention. The drawings contain the following figures:

FIG. 1 illustrates the schematic structure of a system for evaluating messages being processed by a WEB server;

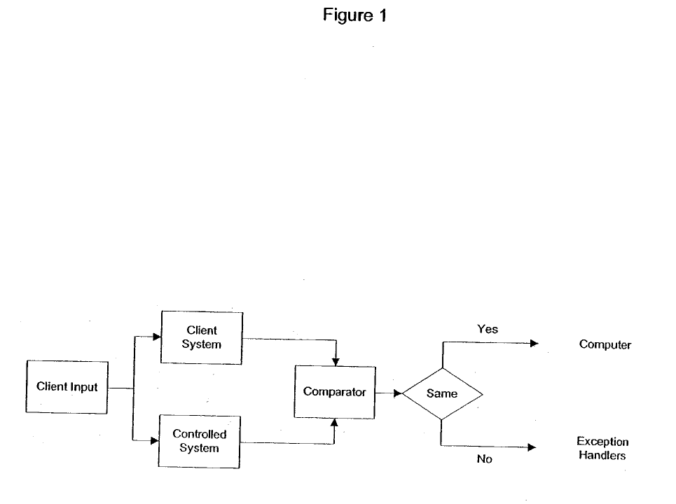

FIG. 2 illustrates the flow of data through one embodiment of a controlled system in accordance with the disclosure herein;

FIG. 3 illustrates one embodiment of a process for validating messages received from a client system in accordance with the disclosure herein;

FIG. 4 illustrates schematically one form of a filter for use in evaluating HTTP input;

FIG. 5 illustrates schematically one form of a validation scheme for use with HTTP input;

FIG. 6 illustrates the flow of data through one embodiment of a controlled system for validating a URL in accordance with the disclosure herein;

FIG. 7 illustrates one embodiment of a process for validating a URL in accordance with the disclosure herein;

FIG. 8 illustrates the flow of data through one embodiment of a process for validating the body of a client message in accordance with the disclosure herein;

FIG. 9 illustrates the flow of data in accordance with one embodiment of a technique for validating client input when a script for capturing data is present on a page delivered by the WEB server;

FIG. 10 illustrates the flow of data in accordance with another embodiment of a technique for validating client input;

FIG. 11 illustrates the data flow in accordance with one embodiment of a closed loop comparison method for validating client input.

### DETAILED DESCRIPTION

Buffer Overflow

Messages that can cause buffer overflows in the WEB server are a common method of launching an attack. Current methods used to prevent buffer overflows are deficient or difficult to implement. They include:

Data validation scripts in the HTML documents. This is a nice feature that assists clients in properly entering data in an efficient manner, but HTML documents may be easily modified or ignored.

Data filtering in the WEB server. First of all, the harm may have already been done before the filters get a chance to do their job. Second, all software programmers would have to be relied upon to actually write code to prevent buffer overflows. They do not, which is a primary reason that WEB servers are vulnerable.

Buffer overflow protection software that is installed on the WEB server. Such software may include: the implementation of a kernel-mode driver that intervenes in the memory management process; a modified compiler that inserts buffer overflow code; software that intervenes with the function that handles the input data; and software that determines whether the input data is a program.

Such software often detects problems after the damage is done, rather than prevents buffer overflows. It also is usually operating system specific [provides no cross platform capability]. It may require recompilation of all software on the WEB server, if the source code is available. It also may use system resources that curtail performance, and often reports a buffer overflow or attempt to cause a buffer overflow erroneously.

Harmful Messages

Current methods to prevent harmful data from affecting the WEB server are based on identifying and preventing (i.e., blocking) known harmful data. Viruses, Trojan Horses, Script Programs masquerading as harmless data and other methods are discovered after an attack has taken place. The intrusion software is analyzed and software antidotes are developed and distributed. These antidotes are designed to identify and block the intrusion software.

Such software: is developed after successful attacks have taken place; may be unique for each instance of intrusion software; is installed for each instance of intrusion software; and is not generally capable of filtering all client messages in real time.

Message Validation System

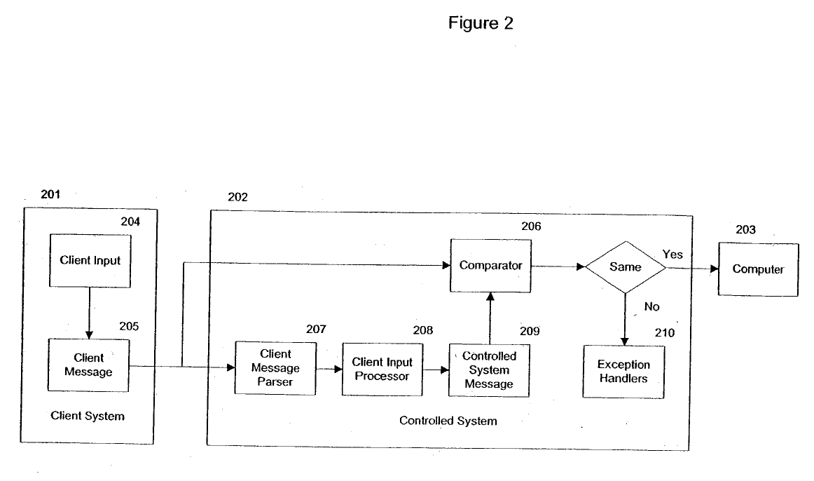

One embodiment of this system compares the outputs of two like systems running the same software and receiving the same inputs and is illustrated in FIG. 2. One system is an uncontrolled client system 201. The other is a controlled system 202 that resides between the client system and the protected computer 203. The client system 201 captures client input 204 (selections and data entry) and creates a client message 205 which is transmitted to the controlled system 202. The controlled system 202 inputs the client message 205 to the comparator 206 and the client message parser 207. The parser 207 extracts the client input from the client message and submits it to the client input processor 208. The client input processor 208 creates a controlled system message 209. The client message 205 created by the client system 201 and the controlled system message 209 created by the controlled system 202 are compared 206. If the messages are the same, the client message is passed to the protected computer 203. If they are not, they are passed to handlers 210 for further processing.

In the embodiment used to describe the system, the client system 201 is a WEB client, the protected computer 203 is a WEB server and the controlled system 302 resides between them and intercepts client messages (requests) and server messages (responses).

In order to more clearly describe the system, a specific embodiment is used wherein the computer system is a WEB server and the client system is a WEB client using a browser.

There are three major elements of a client message that may be validated by the controlled system. They include the HTTP, the URL, and the client message body. The HTTP specifications define a message protocol that is the same for all WEB sites. The URL or destination address is unique. The client message body contains unique client selections and data entry.

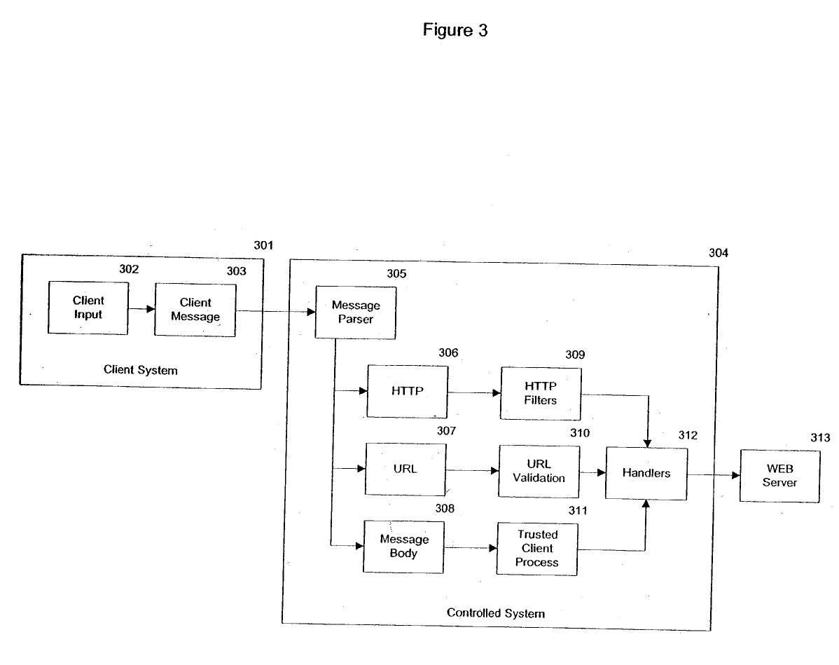

As shown in FIG. 3, the client system 301 accepts input from the client 302 and creates a client message 303 that is transmitted to the controlled system 304. The client message is parsed 05 into the three major elements; HTTP 306, URL 307 and message body 308. Each of these elements is subjected to processes that ensure validity. The HTTP content is subjected to HTTP filters 309 that validate conformance to specifications. The URL is validated 310 by comparing it to (looking it up) in a directory of valid WEB server URLs. The message body (form data) is validated by a trusted client process 311 wherein the client input is re-entered into the controlled system which will produce a valid output. The results of the three validation methods are processed by handlers 312 which may pass all or part of the client message to the WEB server 313. Each validation process is described below.

HTTP Validation

HTTP specifications define client message (request) formats and encoding requirements that WEB servers comply with. The controlled system includes a set of “generic” data filters designed to ensure that client messages conform with these requirements.

HTTP Filter Methods

The data filters use one or more filter methods listed below. The may include:

String—The element to be filtered is compared to an exact or literal string.

Format—The arrangement of elements.

Encoding—An element may consist of text, images, files etc. and be encoded in numerous ways. Encoding methods are specified and filters are developed to validate conformity.

Maximum length—An element may and whenever possible should have a maximum number of allowable characters.

Numeric value—Validates a numeric value is =, <, > an expected value.

Exclusivity—Only one selection from a group or list.

Required—Some elements are required.

Position—Elements that appear in a specific or relative position in the message.

Filtering elements may employ a combination of methods. For example, a field may have a fixed string component “Content-Length: ” and a variable component “106”. The filter method String is used to validate the fixed component “Content-Length: ” and the filter methods Encoding and Maximum Length are used to verify the variable component “106” is ASCII numeric and does not exceed a predefined maximum limit.

These are examples of filter methods used by the data filters. Additional methods may be defined and added as needed.

HTTP Filter Builder

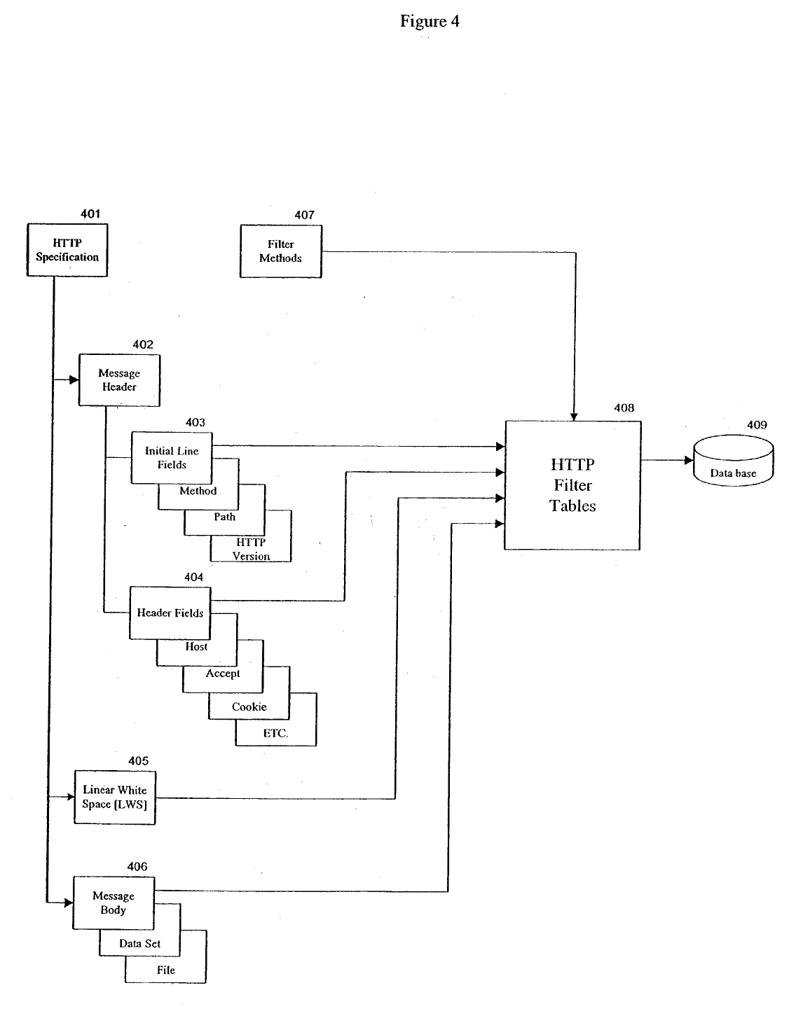

As shown in FIG. 4, the HTTP specification 401 defines requirements that client messages comply with. A client message consists of the following elements and format:

Message Header 402.

Initial line 403 consists of three fields: Method, Path and HTTP version.

Header fields 404 consists of one required header field [Host] and approximately fifty optional header fields.

Linear White Space line 405. This would appear as a blank line on a display.

Message Body 406.

The message body is optional for GET and POST methods. In addition to being validated for HTTP specification compliance, its content is subjected to the client message body validation process.

The client message attributes defined by the HTTP specifications 401 and the filter methods 407 are combined to form the HTTP filter tables 408 which in turn are stored in a data base 409.

HTTP Filter Builder Example

What the HTTP specifications require and how the data filters are developed is described by using an example client message, parsing it, defining the element attributes and determining the filter methods to be used.

Suppose the following is an example client message:

Initial line POST/cgi-bin/pizza-order.cgi HTTP/1.1

Line 2 Host: www.cecorp1.com:80

Line 3 Accept: image/gif, image/jpeg, audio/mpeg, audio/basic, application/msword, application/vnd.ms-project, application/vnd.ms-excel, */*

Line 4 Content-Type: application/x-www-form-urlencoded

Line 5 Content-length: 106

Line 6 Connection: Keep-Alive

Line 7 User-Agent: Mozilla/4.61 [en] (OS/2; U)

Line 8 Accept-Language: en-us

Line 9 From: John@jmarshall.com

Line 10 Cookie: PopUnder=1

Line 11 [Linear White Space], CRLF

Line 12 name=James&crust=Thin&pizzasize=jumbo&toppings=Ham&pizzasticks=Y &pizzadip=Y&pizzaform1=Click+here+to+order

The format of the client message consists of:

A head:

Initial line

Lines 2 thru 10 are Header fields.

Note: The Host: Header field is required. Zero or more additional Header field lines are optional. Header fields may appear in any order.

A blank line:

Note: Line 11 is a blank line [Linear White Space is optional, a CRLF is required] that separates the head from the body.

The message body:

Note: Line 12 is an optional message body [e.g. form data]

Client Message Parser

The values shown in bold print are those used in the example client message.

Initial line. POST/cgi-bin/example.pl HTTP/1.1 consists of three fields:

Field 1. Method: POST—Although not labeled, the first field of a client message is the Method field. There are 8 valid methods including: OPTIONS; GET; POST; HEAD; PUT; DELETE; TRACE; and CONNECT. The end of the Method field is signified by a space.

Field 2. Path:/cgi-bin/example.pl—Although not labeled, the sequence of characters following the Method value is the Path. It defines the Path to the requested resource in the host. Valid paths for a specific host are captured by the trusted client process described later. The end of the path is signified by a space.

Field 3. HTTP version: HTTP/1.1—Although not labeled, the sequence of characters following the Path value is the HTTP version. There are 3 valid HTTP versions including: HTTP/0.9, HTTP/1.0, and HTTP/1.1. The end of the HTTP version is signified by a CRLF. This also signifies the end of the Initial line and the beginning of the Header fields.

Line 2 thru 10. Header fields.

There are a total of approximately 48 Header field types, 9 of which appear in the example client message. The only required Header field is Host:. Header fields may appear in any order but they are located in the Header field area between the Initial line and the blank field. Header fields have a name component e.g. Host: and value component e.g.www.cecorp1.com:80.

The end of each Header field is signified by a CRLF. The end of the Header field area is signified by an additional CRLF which may or may not have Linear White Space preceding it. This also signifies the beginning of the client message body.

A filter table for each field or group of fields that make up the client message head is created. The attributes of each message element defined in the HTTP specification are considered when determining the filter methods to be used. The following tables serve to describe the HTTP filter building process.

TABLE 1
Field = Method

| Value | Required | Exclusive | String | Handlers |
|---|---|---|---|---|
| OPTIONS | Yes | Yes | Yes | TBD |
| GET | | | | |
| POST | | | | |
| HEAD | | | | |
| PUT | | | | |
| DELETE | | | | |
| TRACE | | | | |
| CONNECT | | | | |

TABLE 2
Field = Path

| Value | Required | Exclusive | String | Handlers | note |
|---|---|---|---|---|---|
| Example: /cgi-bin/ | Yes | Yes | Yes | TBD | 1 |
| pizza-order.cgi | | | | | |

Path: There are typically many paths for a specific host. These are captured by the HTML and trusted client parser processes described later.

TABLE 3
Field = HTTP version

| Value | Required | Exclusive | String | Handlers |
|---|---|---|---|---|
| HTTP/0.9 | Yes | Yes | Yes | TBD |
| HTTP/1.0 | | | | |
| HTTP/1.1 | | | | |

TABLE 4
Name = Host:

| Value | Required | Exclusive | String | Handlers |
|---|---|---|---|---|
| www.cecorp1.com:80 | Yes | Yes | Yes | TBD |
| www.cecorp2.com:80 | | | | |

Host: There may be more than one host. Each host is captured by the HTML and trusted client parser processes described later.

TABLE 5
Name = Accept:

| Value | Sub-Value | # possible | | | Maximum | |
|---|---|---|---|---|---|---|
| [mime type] | [mime sub-type] | Sub-Values | String | Encode | Length | Handlers |
| application/ | msword | 275 | Yes | Yes | TBD | TBD |
| | vnd.ms-excel | | | | | |
| | vnd.ms-project | | | | | |
| audio/ | audio/mpeg | 30 | | | | |
| | basic | | | | | |
| image/ | gif | 25 | | | | |
| | jpeg | | | | | |
| | * | | | | | |
| message/ | | 8 | | | | |
| model/ | | 12 | | | | |
| multi-part/ | | 13 | | | | |
| text/ | | 30 | | | | |
| video/ | | 12 | | | | |
| */ | * | | | | | |

There are 8 values for the Accept: name and they are listed. There are approximately 400 sub-values, too many to list in this table. The sub-values used in the example client message are shown.

The total number of currently possible sub-values for each value is shown in the table.

The value */ means any value.

The sub-value /* means any sub-value for the value preceding this expression.

Maximum lengths are not specified. Default or preferably established values are entered.

All Header field names are subjected to String filtering. In this case Accept:.

All Header field types are subjected to String filtering. In this case the two of nine media types used in the example client message.

All Header field sub-types are subjected to String filtering. In this case all the sub-types listed in the table.

TABLE 6
Name = Content-Type:

| Value | Sub-Value | # possible | | | | |
|---|---|---|---|---|---|---|
| [mime type] | [mime sub-type] | sub-values | String | Encode | Max Length | Handlers |
| application/ | x-www-form- | 275 | Yes | Yes | TBD | TBD |
| | urlencoded | | | | | |
| audio/ | | 30 | | | | |
| image/ | | 25 | | | | |
| message/ | | 8 | | | | |
| model/ | | 12 | | | | |
| multi-part/ | | 13 | | | | |
| text/ | | 30 | | | | |
| video/ | | 12 | | | | |
| application/ | x-www-form- | 275 | Yes | Yes | TBD | TBD |
| | urlencoded | | | | | |
| */ | | | | | | |

Note the similarity to Accept:. The same values [mime types] and sub-values [mime sub-types] apply.

TABLE 7
Name = Content-Length:

| Value | Encode | Maximum Length | Numeric Value | Handlers |
|---|---|---|---|---|
| 106 | ASCII Numeric | TBD | Value = or < 106 | TBD |

TABLE 8
Name = Connection:

| Value | Exclusive | String | Handlers |
|---|---|---|---|
| Close | Yes | Yes | TBD |
| Keep-Alive | | | |

This process of parsing, tabulating and establishing the filter methods to be used on client message heads is repeated until all Header fields are defined.

Note that the system uses the highest filter method[s] that can be used. When String method cannot be used, Format is used and so on until in the worst case, an element may be filtered for Encoding and Maximum Length. Add to this other filter methods that may apply including Position, Required and Exclusivity.

Also notes that the client message, interpretation of HTTP specifications, filter attributes, filter methods and actions taken are used as a means of describing the system's techniques and methods. Those of skill in the art will recognize that these systems and techniques may be applied in a way that includes variations which include changes based upon variations in the types of messages to which they are applied.

Validating a Client Message for HTTP Compliance

The controlled system intercepts client messages bound for the WEB server and subjects them to validation processes. Client messages are comprised of three major elements; the HTTP header, destination URL and message body. Each element is parsed and validated. The HTTP header is validated by subjecting it to the HTTP filters.

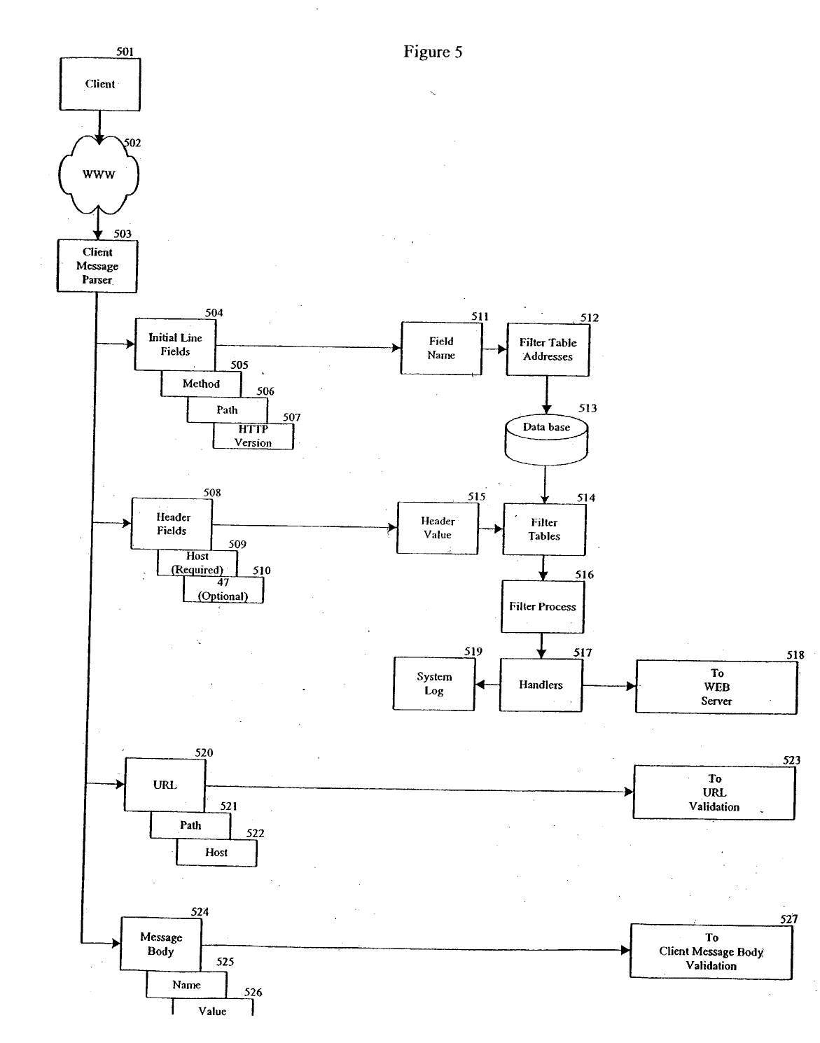

As shown in FIG. 5, the client message header can be filtered using the HTTP filter tables. The client 501 submits a message destined for the WEB server via the WWW 502. The controlled system intercepts the message and subjects it to the client message parser 503. The initial line 504 of the message contains three header fields. The first field name is method 505, the second field name is path 506 and the third field name is HTTP version 507. Their names 811 address the corresponding filter table 812 in the data base 813. Each field is processed separately. Each field has a unique filter table. The header field value 815 is loaded into the retrieved filter table 814 and filtered using the filter methods specified by the table.

Note: A field consists of a field name and a field value. The name is used as a data base address of the filter table. The value is a variable and is subjected to the filter process for validation.

The results of the filter process 516 are processed by handlers 517 that pass the validated fields on to the WEB server and or other processes e.g. system log 519.

The process is the same for the header fields 508. Only the Host Header field 509 is required. There are approximately 47 optional header fields 510 which are defined in the HTTP specification and have corresponding filter tables developed for them.

The URL 520 is unique to the WEB site and specific HTML documents. It consists of the path field 506 [the second field of the HTTP header initial line] and the host header field value 509. They are combined to form the destination URL 520 which is sent to the URL validator 523.

The message body 524 is unique to the HTML document. It consists of name 525 and value 526 pairs which are sent to the client message body validator 527.

Trusted Client Process

The other elements of the client message; destination URL and message body are unique to the WEB site and individual HTML documents. A set of generic filters will generally not suffice. Methods that validate compliance with HTML document commands and browser execution of those commands may provide a better result. The system described herein handles the unique requirements by defining them with a trusted client.

A trusted client is an authorized person preferably on a secure network [private or Virtual Private Network] using an authorized client system. An automated trusted client is a programmable system that may be used to test HTML documents, verify the WEB server is running correctly and paths are complete and lead to valid destinations. The controlled system is an automated trusted client.

The trusted client process is used to configure the controlled system. All valid URLs are invoked and captured. They may be encoded as described in the URL validation process. Client message differences due to script or browser plug-ins are detected and captured. Methods to reconcile such differences are described in the client message body validation process.

URL Validation

The trusted client process is used to invoke and capture valid WEB site URLs. Even URLs that are created or modified by script or browser plug-ins. In addition, The relationship of an HTML document URL [source] and the URLs that may be generated by the HTML document [destinations] are captured and stored in the controlled system. A client message created as a result of a form submit contains the destination URL [action attribute of the form]. In order to load the HTML document containing that form into the controlled system browser, the source URL is determined. This is accomplished because the URL relationships have been determined and captured. URLs may be modified or tagged for additional security and information.

For example, the URLs on an HTML document may be tagged or replaced by a hash code in order to: (1) prevent the client from seeing and thereby possibly exploiting actual resource paths; (2) uniquely construct URLs for each specific client thereby enabling the controlled system and WEB server to identify the client; and (3) establish a unique form action attribute for every form. In many cases, the same form and/or form action may be used on multiple HTML documents. A unique form action identifies the HTML document it came from.

URL Validation Table

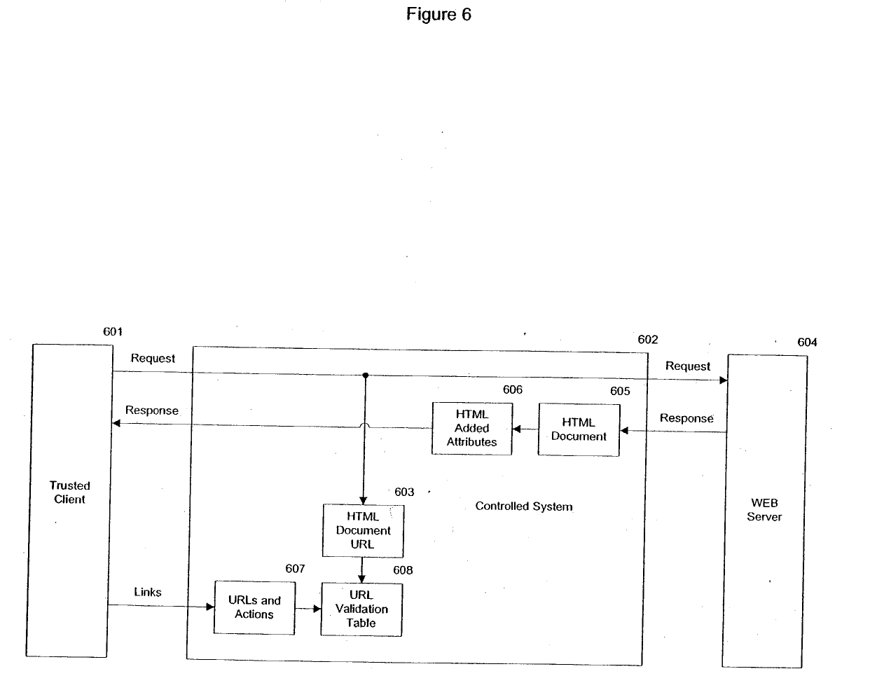

As shown in FIG. 6, the trusted client 601 sends a request to the controlled system 602. The controlled system 602 captures the URL of the requested HTML document 603 [source URL] and forwards the request to the WEB server 604. The WEB server 604 responds by transmitting the requested HTML document 605 to the controlled system 602. The controlled system 602 optionally modifies the HTML document 606 to provide unique form actions and/or encoding. The controlled system 602 transmits the modified HTML document 606 to the trusted client system 601. The trusted client system 601 invokes the links [destination URLs] including form submittals and transmits them to the controlled system 602 where they are captured 607. The source URL 603 and the destination URLs 607 are valid and related links. Their values and relationships are captured and tabulated 608. By having established the relationship of HTML document [source] URLs with the link [destination] URLs, the controlled system can readily determine the source URL by looking up the destination URL.

URL Validation Process

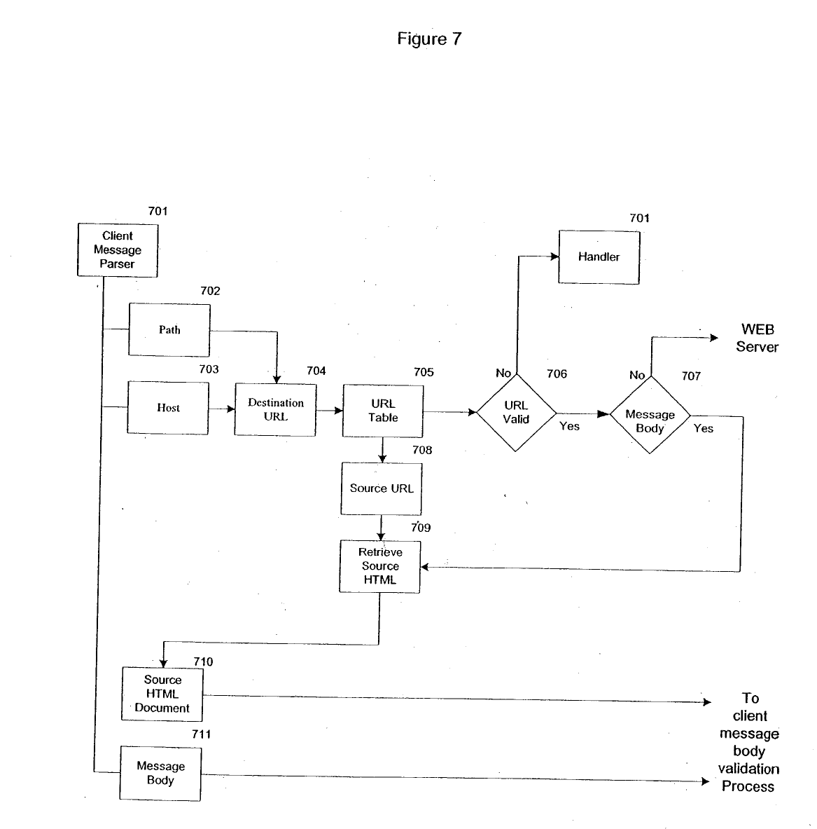

As shown in FIG. 7, the client message is parsed 701. The path 702 from the initial HTTP line and the host 703 value from the host header field are captured and combined to form the destination URL 704. The destination URL is validated by looking it up in the valid URL table 705.

Note that in addition to validating the destination URL, the URL validation process determines if the source HTML document needs to be retrieved and loaded into the controlled system browser so it can validate the client message body.

If the destination URL is valid 706 and there is no message body 707, the destination URL is passed to the WEB server for processing. If there is a message body 707, the source HTML document is determined, retrieved and loaded into the controlled system browser. The URL table 705 is used to correlate the destination URL with the source URL 708. The source URL 708 is used to retrieve the HTML document 709 that was used to create the client message. The HTML document 710 and the message body 711 are sent to the client message body validation process.

Client Message Body Validation

The message body contains the client input. Selections and data entry are formatted in data sets comprised of a name and a value. The data sets are extracted from the client message and used to re-enter the values into the controlled system.

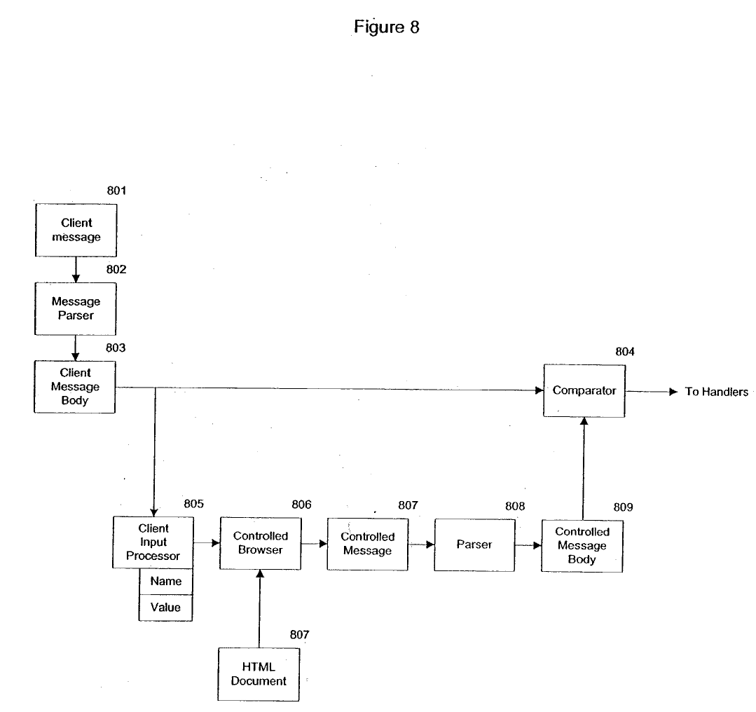

As shown in FIG. 8, the client message 801 is parsed 802 and the client message body 803 is input to the comparator 804 and the client input processor 805. The controlled system browser 806 is loaded with the same HTML document 807 that was used to create the client message in the client system.

The client input processor 805 uses the name component of the data set to identify the form control used to enter the selections or data. For text fields and text areas, the value component of the data set is entered into the form control. For form controls where selections are made, the value identifies the selection the control system makes. For form controls that are read only or hidden fields, values are not entered.

The control system browser 806 will produce a controlled message 808 containing the three major elements. The controlled message is input to a parser 809 that extracts the controlled message body 810 created by the controlled system. The message bodies from the client system and the controlled system are compared 804. The results of the comparison are passed on to handlers.

Capturing Client Input

There are several methods for capturing client input. These may include but are not limited to those described below.

One technique is extracting the client input from the client output [client message body]. This method is effective when the client input is unaltered by the client system. However, the client input may be modified by script in the HTML document or by browser plug-ins. Such instances are readily detected by the comparator and may be handled in several ways. For example, when the input does not match the output, the HTML document less the modifying script may be transmitted to the client for re-entry of selections and data. Taking this one step further, a new HTML document may be created containing the affected form controls. In either case, these alternatives allow the control system to receive actual user input unaffected by script.

Other methods may be employed wherein the actual client inputs are captured at the source, transmitted to the control system and input to the HTML document. Methods include:

In a second technique the WEB server HTML document may be modified by the controlled system to include a capability to capture client input that is submitted along with the normal client message. Script may be added to each form control that captures the exact client input and the order of entry and writes it to an added field before it can be modified by other script or plug-ins. When the added field contents are entered into the controlled system, the actions of the client will be duplicated.

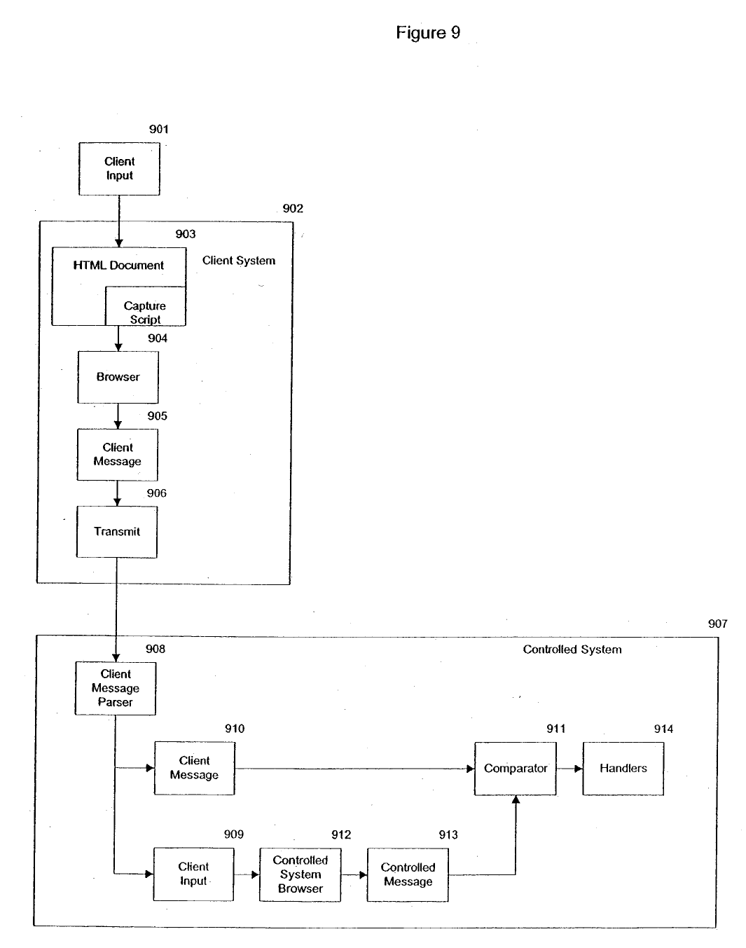

As illustrated in FIG. 9, the client 901 makes selections and enters data into the client system 902. The client is using an enhanced HTML document 903 that includes the capability to capture every client input and the order they were entered. The client system browser 904 creates a client message 905 that includes the additional client input field. The client message 905 is transmitted 906 to the controlled system 907. The client message is parsed 908 separating the field containing the client input 909 from the normal client message 910. The client message 910 is input to the comparator 911. The client input 909 is entered into the controlled system browser 912 that creates a trusted message 913. The client message 910 and the trusted message 913 are compared 911. The result is handled by handlers 914.

Note that the modifications to the HTML document are transparent to the client system and the WEB server. No changes to either system are required.

In a third technique a parallel windowless [one that cannot be seen] HTML document may be sent to the client that monitors and captures client input. The client input is transmitted to the control system in addition to the normal client message.

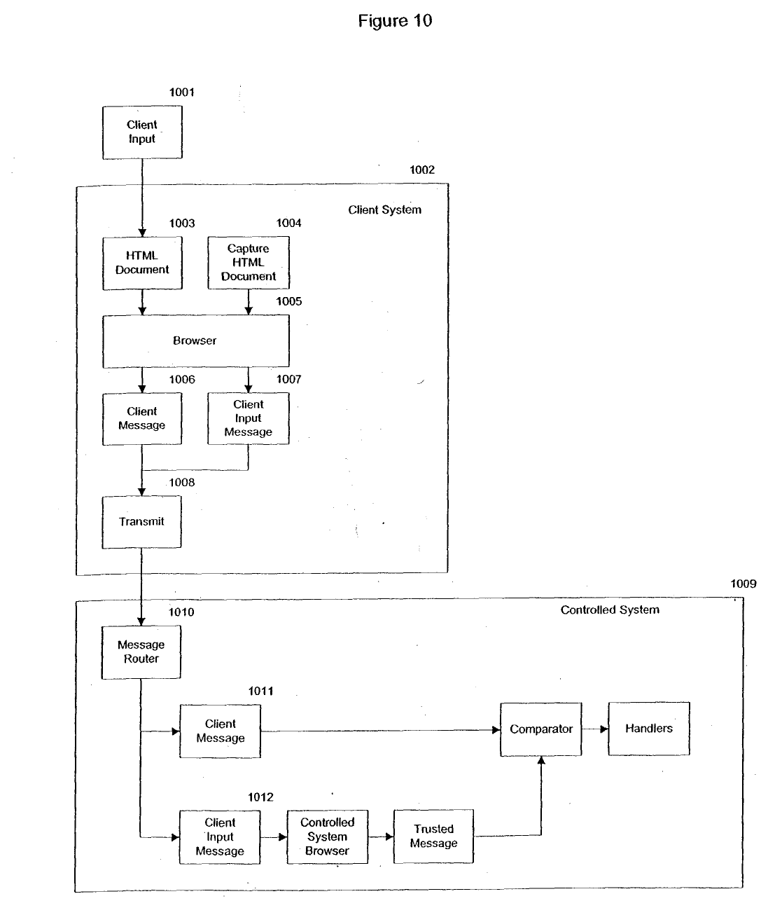

As can be seen in FIG. 10, the client receives two HTML documents, the unaltered document 1003 and a special HTML document 1004. The client 1001 makes enters data into the client system 1002 using the unaltered HTML document 1003. The browser 1005 creates a client message 1006. The special HTML document 1004 has the ability to monitor and capture client inputs using standard API features of the browser 1005. A client input message 1007 is created. It contains the client selections and data entry and the order they were entered. Both the client message 1006 and the client input message 1007 are transmitted 1008 to the controlled system 1009. The messages are routed 1010 to the client message 1011 and client input 1012. From here the process is the same as that described for the enhanced HTML client input capture method described above.

Note that no modification to the original HTML document is required nor are any modifications to the client system and the WEB server.

A fourth method of capturing client input that is modified by script or plug-ins is to determine their value by applying closed servo loop technology on data. The client system and the controlled system are functional equivalents and will produce the same output given the same input.

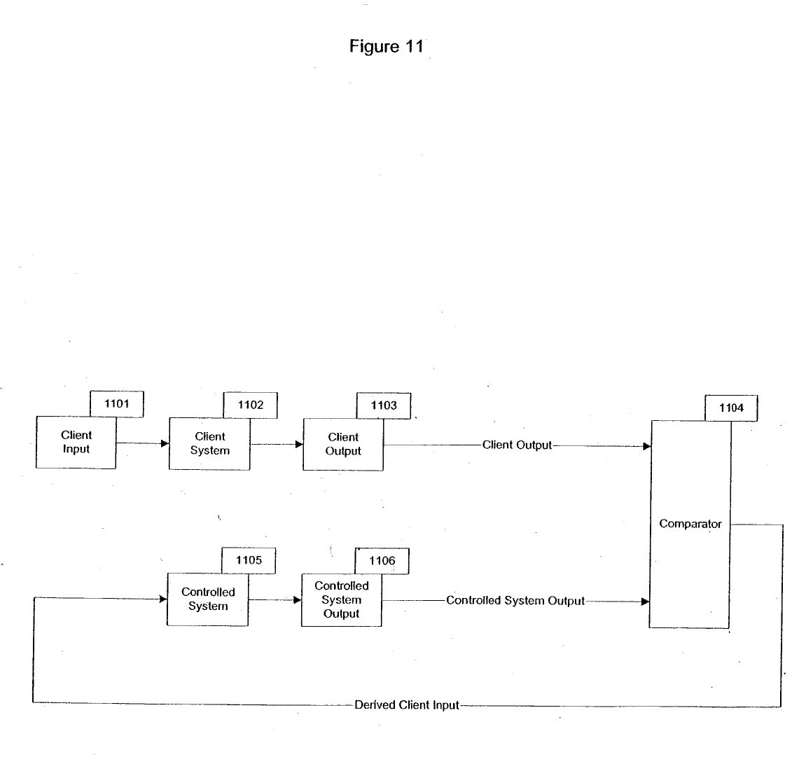

As FIG. 11 shows, the client inputs a value 1101. The client system 1102 modifies the client input and creates a client output 1103. The client output is input to a comparator 1104. The output of the comparator 1104 is input to the controlled system 1105. The controlled system modifies the input in the same way the client input was modified by the client system. They are functional equivalents acting on the same HTML document and executing the same input modifying instructions. The controlled system output 1106 is input to the comparator 1104. The comparator detects the client output is not equal to the controlled system output and changes its output in a direction that reduces the difference until there is no difference. When this condition is reached, the client input=controlled system input and client system output=controlled system output.

Further method used to capture client input include but are not limited to: installing a plug-in to the client browser that is capable of capturing client input and transmitting it to the controlled system; installing a special or customized browser capable of capturing client input and transmitting it to the controlled system; and installing a software program on the client system that is capable of capturing client input and transmitting it to the controlled system.

Methods may be combined to improve the results. The trusted client process is used to discover and reconcile differences between client and controlled system messages. For example, when client inputs are captured and re-entered into the controlled system, the output of both systems should be identical. This is true even when script or plug-ins modify the user input as long as both systems have the same HTML document and/or plug-ins installed. However there are exceptions to this rule.

One such exception is when the client system accesses a random number or Time Of Day [TOD] from its operating system and inputs it to the client message body. The TOD fields would not be the same in both systems. The controlled system would detect the difference during the trusted client process. The WEB master would be required to define the allowable attributes of the new or modified fields for handling by the exception handlers.

For example: An HTML document contains script that accesses the operating system TOD and adds it to the client message body. Both systems will create the TOD field but their values will be different. The trusted client process would detect this condition recognizing the client message as valid but different. In this case, the client message TOD value could be used as an input to the controlled system in place of the controlled system TOD value. Another method of handling such differences is to create a filter similar to those created for the HTTP filter. Such filters would use the filter methods and attributes of the field defined by the form control or WEB master. The field could be filtered for maximum length, encoding and position.

### EXAMPLES

The systems and techniques above may be applied to other instances where a computer or server is to be protected from faulty data input. Two such example applications are provided.

In the first example, protection of a traditional [legacy system] mainframes or servers is demonstrated. This system may be used in a similar manner as that described for WEB servers with some variances in implementation. Computers that run applications designed to communicate with CRT terminals or PCs with terminal emulations are vulnerable to invalid client message submittals. Client messages comply with communication protocols and content formats. For the purpose of describing this embodiment, the type of CRT terminal or terminal emulation is a page mode terminal that has format protection. Such terminals include IBM 5250 and 3270, Burroughs [Unisys] poll/select and NCR poll/select.

There are two major elements of a client message: the communication protocol, which is common to terminals of the same type, and the message body which contains client selections and data entry.

The communications protocol for each terminal type is well defined. A set of filters that validate compliance with specifications is used. This is similar to the building and using of the HTTP filter described for WEB server protection.

The message body is created by the client input to a form. The form is loaded into the client terminal and a controlled system [trusted client terminal]. The client makes selections, enters data and creates a client message which is transmitted to the controlled system. The client inputs are extracted from the client message and re-entered into the controlled system. The controlled system creates a controlled message that complies with communication protocol requirements and the format defined by the form. This is the message that is transmitted to the protected computer. Valid client inputs appear in the proper order, do not exceed maximum field lengths and comply with encoding requirements. The controlled system as well as any valid client system rejects or limits client input and enforces compliance.

The protected computer message or form is requested by the client submitting a unique message containing the form address. Valid request messages are captured. The client requests are compared to the captured valid requests. This is a similar to the building and using of the URL validation process described for WEB server protection.

In a second example application, filters are built as a result of building HTML documents. The system employs methods for building and using message filters [HTTP validation process] for computer systems already in operation. This embodiment describes how these methods may be used to create and use filters for HTML documents in a development environment when the HTML documents are being created or modified. HTML authoring software enables authors to create HTML documents containing forms, form controls, links and scripts. The HTML authoring software can be enhanced to include the ability to build document specific filter tables. The HTML authoring software is expanded to include a function that requires the author to enter set and extended attributes required by the filters. They are entered into the document specific filter table along with the corresponding filter methods and handlers defined for each form control. The tables are loaded into the controlled system data base. Another method of building the the document specific filter table is for the HTML authoring software to add the set and extended attributes into the HTML document or to build an export file. The HTML parser can capture the attributes from the HTML document or import the file and enter the attributes into the tables. These enhancements may be added to the HTML authoring software as a plug-in interfaced to the authoring software API or as a stand alone complementary software program.

What is claimed is:

1. A system for validating computer input messages, comprising:
a set of data filters that validate that the computer input messages are compliant with a set of communication protocol requirements and,
a process that validates message content by capturing client selections and data entry from a client system and sending the selection and data entry to a functionally equivalent controlled system that contains a client rule set and an input control program thereby producing a valid message that is submitted to a protected computer system.

2. The system of claim 1 wherein the controlled system resides between a client system and the protected computer and intercepts all messages.

3. The system of claim 1 wherein the controlled system is functionally equivalent to a valid client system.

4. The system of claim 1 wherein a client system and the controlled system receive the same rule set from the protected computer.

5. The system of claim 1 wherein the controlled system contains a functionally equivalent input control program as a valid client system.

6. The system of claim 1 wherein the client selections and data entry are captured and re-entered into the controlled system.

7. The system of claim 1 wherein the controlled system will produce a controlled message that is compliant with communication protocol requirements.

8. The system of claim 1 wherein the controlled system will produce a controlled message that is compliant with the rule set and input control program.

9. The system of claim 1 wherein the controlled system will produce a controlled message that is functionally equivalent to a valid client message receiving the same client input.

10. The system of claim 9 wherein the controlled message is input to the protected computer.

11. The system of claim 6 wherein the client message contains the exact client input, the input will be extracted and re-entered into the controlled system.

12. The system of claim 6 wherein the client message contains the client selections and data entry as modified by the rule set.

13. The system of claim 12 wherein the client input is captured before it is modified by the rule set and input to the controlled system.

14. The system of claim 13 wherein the client input is monitored and captured by an apparatus or program.

15. The system of claim 13 wherein the client input is monitored and captured by additions and/or modifications to the rule set.

16. The system of claim 13 wherein the client input is monitored and captured by additions and/or modifications to the input control program.

17. The system of claim 12 wherein the client input is derived by varying the controlled system input until the controlled system output is equivalent to the client system output.

18. The system of claim 12 wherein the client system rule set is disabled from making modification to client input and the client re-enters selections and data into the disabled rule set thereby producing a client message that contains the exact client selections and data entry.

19. The system of claim 1 wherein the communication protocol is the same for any client systems accessing the protected computer and, a set of filters which is based on the communication protocol specifications and which uses a set of common data filter methods is developed.

20. The system of claim 19 wherein the client message communication protocol elements are extracted from the client message and subjected to the data filters for validation and handling.

21. The system of claim 1 wherein a trusted client invokes the process and the controlled system captures the links to a protected computer resource.

22. The system of claim 21 wherein a client message is validated by comparing it to the captured links created by the trusted client.

23. The system of claim 1 wherein a stateless condition may exist between the client and controlled systems and wherein the process reestablishes a state condition.

24. The system of claim 23 wherein a trusted client process captures and relates a link to the rule set and the links the rule set may create thereby allows the appropriate rule set to be loaded into the controlled system for the submitted client message.

25. The system of claim 23 wherein the rule set sent by the protected computer to both systems is marked for identification.

26. The system of claim 25 wherein the rule set marking is submitted along with the normal client message and to allow the controlled system to identify the client system.
